(19) United States
(12) Patent Application Publication
(10) Pub. No.: US 2021/0006121 A1
(43) Pub. Date: Jan. 7, 2021

(54) MOUNTING METHOD OF A ROTOR ASSEMBLY COMPRISING A BEARING INTO A FRAME COMPRISING ADHESIVE

(71) Applicant: Dyson Technology Limited, Wiltshire (GB)

(72) Inventors: David IONS, Swindon (GB); John Declan STOTT, Bristol (GB); Thomas Richard STAFFORD, Bath (GB)

(73) Assignee: Dyson Technology Limited, Wiltshire (GB)

(21) Appl. No.: 16/976,790

(22) PCT Filed: Feb. 19, 2019
(86) PCT No.: PCT/GB2019/050451

§ 371 Date: Aug. 31, 2020

(30) Foreign Application Priority Data
Mar. 1, 2018 (GB) 1803351.4

(51) Int. Cl. H02K 5/173; H02K 7/04; H02K 7/08; H02K 7/14; H02K 15/14; H02K 11/215; H02K 21/14

(52) U.S. Cl. CPC H02K 5/1732; H02K 7/04; H02K 7/083; H02K 21/14; H02K 15/14; H02K 11/215; H02K 7/14

(57) ABSTRACT

A method of mounting a rotor assembly to a frame of an electric motor. The method includes providing a rotor assembly having a bearing and a frame having a bearing seat. The bearing seat has an aperture. The bearing and/or the internal surface of the bearing seat has an annular groove. The method includes locating the bearing within the bearing seat. The method includes injecting an adhesive through the aperture into the annular groove. The method includes affecting relative movement between the bearing and the bearing seat. The method includes curing the adhesive.

### REFERENCE TO RELATED APPLICATIONS

This application is a national stage application under 35 USC 371 of International Application No. PCT/GB2019/050451, filed Feb. 19, 2019, which claims the priority of United Kingdom Application No. 1803351.4 filed Mar. 1, 2018, the entire contents of each of which are incorporated herein by reference.

### FIELD OF THE DISCLOSURE

The present disclosure relates to a method of mounting a rotor assembly to a frame of an electric motor, and to an electric motor.

### BACKGROUND OF THE DISCLOSURE

There is a general desire to improve electric machines, such as brushless electric motors, in a number of ways. In particular, improvements may be desired in terms of size, weight, manufacturing cost, efficiency, reliability and noise.

### SUMMARY OF THE DISCLOSURE

According to a first aspect of the present invention there is provided a method of mounting a rotor assembly to a frame of an electric motor, the method comprising providing a rotor assembly having a bearing, providing a frame having a bearing seat, the bearing seat comprising an aperture, and the bearing and/or an internal surface of the bearing seat comprising an annular groove, locating the bearing within the bearing seat, injecting an adhesive through the aperture into the annular groove, affecting relative movement between the bearing and the bearing seat, and curing the adhesive.

The method according to the first aspect of the present invention may be beneficial principally as the method comprises injecting an adhesive through the aperture into the annular groove, and affecting relative movement between the bearing and the bearing seat.

In particular, injecting an adhesive through the aperture into the annular groove may allow for the adhesive to be applied post-location of the bearing in the bearing seat. This may allow for a cleaner application of adhesive, and may reduce the risk of adhesive contaminating other components during application, compared to, for example, applying the adhesive pre-location of the bearing in the bearing seat.

Furthermore, utilising an annular groove may reduce the chance that adhesive will flow out from between the bearing and the bearing seat in an uncontrolled manner during application of the adhesive. If adhesive is able to flow at the interface between the bearing and the bearing seat in an uncontrolled manner, there is the chance that the adhesive may enter into the bearing itself, which may be extremely detrimental to the bearing and may stop the bearing from functioning completely.

However, by applying adhesive within an annular groove, the total bond surface area may be limited by the dimensions of the groove, which may result in a weaker bond between the bearing and the internal surface of the bearing seat. By affecting relative movement between the bearing and the bearing seat the adhesive can be spread along the interface between the bearing and the bearing seat, thereby increasing the total bond surface area, which may provide a stronger bond.

Furthermore, the relative movement may be carefully controlled, thereby ensuring that the adhesive is only spread by a desired amount. This may reduce the risk of adhesive leaking at the interface. Such leakage may increase the risk of adhesive entering into the bearing itself, which may be extremely detrimental to the bearing and may stop the bearing from functioning completely.

Thus the present invention may provide a method of mounting a rotor assembly to a frame of an electric motor which enables the application of adhesive between the rotor assembly and the frame in a controlled manner, whilst providing for the formation of a strong bond between the rotor assembly and the frame. The provision of a strong bond between the rotor assembly and the frame may reduce the risk of misalignment between the rotor assembly and the frame, and may increase the reliability of operation of the electric motor.

Affecting relative movement between the bearing and the bearing seat may also enable correct alignment of the rotor assembly and frame to be achieved. Correct alignment of the rotor assembly and the frame may be crucial to reliable operation of the electric motor, and hence enabling the components to move relative to one another following the application of adhesive may allow misalignment that occurs during application of the adhesive to be accounted for and corrected.

Affecting relative movement between the bearing and the bearing seat may comprise affecting relative movement between the bearing and the bearing seat in an axial direction, for example in a direction parallel to a longitudinal axis of the rotor assembly. This may be beneficial as this may result in spreading of the adhesive along the interface between the bearing and the internal surface of the bearing seat, thereby increasing the bond surface area. Hence this may result in an increased bond strength between the bearing and the bearing seat. Affecting relative movement between the bearing and the bearing seat may comprise affecting relative movement between the bearing and the bearing seat along an axis coincident with an axis of a shaft of the rotor assembly, for example an axis which defines a rotation axis of the rotor assembly.

The annular groove may be located on the bearing. Locating the bearing within the bearing seat may comprise locating the bearing within the bearing seat such that the aperture and the annular groove are aligned. Affecting relative movement between the bearing and the bearing seat may comprise affecting relative movement between the bearing and the bearing seat such that the aperture and the annular groove are at least partially misaligned.

The aperture and the annular groove may be at least partially misaligned in an axial direction of the rotor assembly, for example such that at least one edge of the annular groove is not coincident with a perimeter of aperture, once relative movement has been affected between the bearing and the bearing seat. This may be beneficial as this may provide a visual indication that the desired spreading of the adhesive to increase the bond strength has occurred.

Locating the bearing within the bearing seat may comprise locating the bearing within the bearing seat such that opposing edges of the annular groove are coincident with corresponding opposing points on the perimeter of the aperture, for example such that opposing edges of the annular groove are tangential to the aperture. This may be beneficial as this may maximise the area of the aperture that is available for insertion of an injection needle tip, thereby enabling correct and/or full alignment of an injection needle tip during adhesive injection. This may reduce the risk of adhesive being incorrectly applied at a wrong location and/or reduce the risk of uncontrolled flow of adhesive during manufacture. The annular groove may have a width corresponding to the width, for example the diameter, of the aperture.

The adhesive may comprise a heat cured adhesive, and may, for example, comprise a structural adhesive. Curing the adhesive may comprise using a heat curing process. This may be beneficial as once the bearing is located within the bearing seat, and adhesive has been injected to the interface between the bearing and the internal surface of the bearing seat, the adhesive within the annular groove is no longer visible and is effectively screened by the bearing seat, save for any adhesive within the aperture. It may therefore prove difficult to ensure the adhesive fully cures using some curing methods, for example using a UV curing method, as it may prove difficult to ensure that the UV light reaches the adhesive. The use of a heat cured adhesive may ensure that the adhesive fully cures, thereby providing a strong and reliable bond.

The method may comprise applying a tacking adhesive at an interface between the bearing and an external surface of the bearing seat, and curing the tacking adhesive before curing the adhesive. This may be beneficial as the adhesive applied through the aperture may have a relatively long cure time and/or the assembly may need to be transported, for example to an oven, for curing, thereby increasing the risk that the bearing and the bearing seat may become misaligned during manufacture. By using a tacking adhesive the rotor assembly may be secured to the frame during the curing process for the adhesive injected through the aperture, thereby inhibiting misalignment of the rotor assembly and the frame.

The tacking adhesive may be applied at a location where the tacking adhesive is visible post-application. This may be beneficial as it may enable the tacking adhesive to comprise an adhesive having a relatively short cure time, such as a UV cured adhesive, for example. UV cured adhesives may have a comparatively short cure time to heat cured adhesives, and hence the tacking adhesive may provide a quick formation of a relatively low strength bond between the bearing and bearing seat, thereby reducing the risk of misalignment between the bearing and bearing seat during manufacture. The method may comprise curing the tacking adhesive using a UV curing process.

It will be appreciated that although the bond provided by the tacking adhesive is relatively low strength compared to the bond provided by the adhesive injected through the aperture, the strength of the bond created by the tacking adhesive will be sufficient to secure the positions of the bearing and the bearing seat during curing of the adhesive applied through the aperture.

The bearing seat may comprise a cut-out through which at least a portion of the bearing is exposed, and the cut-out may, for example, define the interface between the bearing and an external surface of the bearing seat, ie a visible interface. This may be beneficial as it may enable the application of a tacking adhesive at the visible interface, which may allow the bearing and bearing seat to be fixed in position during curing of the adhesive applied through the aperture.

The bearing may comprise a further groove, and the further groove may be exposed through the cut-out. The method may comprise applying tacking adhesive to the further groove. This may be beneficial as the further groove may provide a mechanical key, which may provide the tacking adhesive bond with sufficient strength to perform its function of retaining the bearing and bearing seat in position during curing of the adhesive applied through the aperture.

According to a second aspect of the present invention there is provided an electric motor manufactured according to the method of the first aspect of the present invention.

According to a third aspect of the present invention there is provided a method of mounting a rotor assembly to a frame of an electric motor, the method comprising providing a rotor assembly having a bearing and a frame having a bearing seat for receiving the bearing, the bearing seat comprising an aperture, and the bearing comprising an annular groove, locating the bearing within the bearing seat such that the aperture and the annular groove are aligned, injecting an adhesive through the aperture into the annular groove, affecting relative movement between the bearing and the bearing seat such that the aperture and the annular groove are at least partially misaligned, and curing the adhesive.

According to a fourth aspect of the present invention there is provided an electric motor comprising a rotor assembly having a bearing, and a frame having a bearing seat, wherein the bearing seat comprises an aperture, the bearing comprises an annular groove, and the annular groove is at least partially misaligned with the aperture.

It will be recognised that preferential features of aspects of the invention may be equally applied to other aspects of the present invention, where appropriate.

### BRIEF DESCRIPTION OF THE FIGURES

In order to better understand the present invention according to various aspects, and to show more clearly how various aspects of the invention may be put into effect, the invention according to various aspects will now be described, by way of example, with reference to the following drawings:

FIG. 1 is a block diagram of a first embodiment of a method of mounting a rotor assembly to a frame of an electric motor according to a first aspect of the present invention;

FIG. 2 is a front view of an electric motor according to a first aspect of the present invention;

FIG. 3 is a perspective view of the electric motor of FIG. 2 with its stator core assemblies removed;

FIG. 4 is an enlarged view of the dashed region of FIG. 3;

FIG. 5 is a rotated view of FIG. 4;

FIG. 6 is a front view of the rotor assembly of the electric motor of FIG. 2;

FIG. 7 is a perspective view of the frame of the electric motor of FIG. 2;

FIG. 8 is a sectional view taken along the line A-A of FIG. 7;

FIG. 9 is a sectional view taken along the line B-B of FIG. 2;

FIG. 10 is an enlarged view of the dashed region of FIG. 9;

FIG. 11 is a block diagram of a second embodiment of a method of mounting a rotor assembly to a frame of an electric motor according to the first aspect of the present invention.

### DETAILED DESCRIPTION OF THE DISCLOSURE

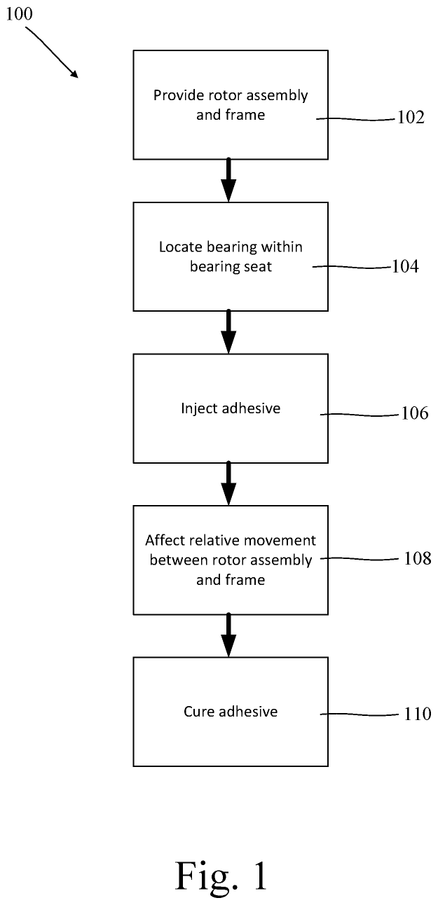

A first embodiment of a method, generally designated 100, of mounting a rotor assembly 12 to a frame 14 of an electric motor 10, is shown in the block diagram of FIG. 1.

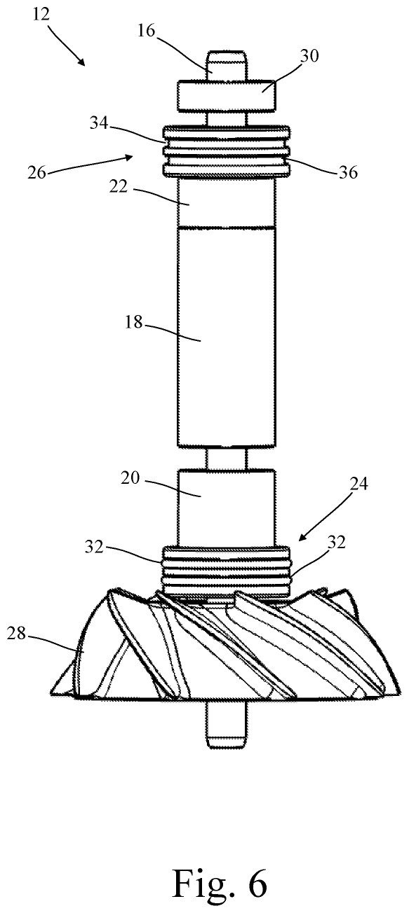

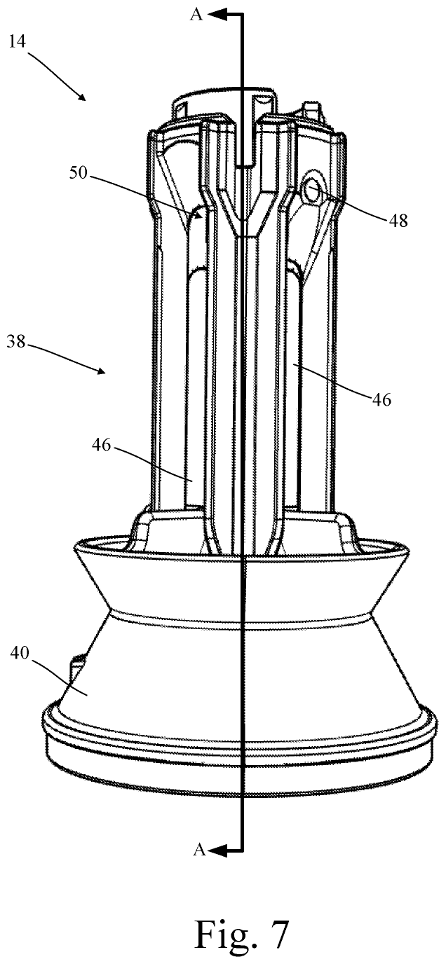

The method 100 comprises an initial step 102 of providing a rotor assembly 12 having a bearing 26 and a frame 14 having a bearing seat 44. A suitable rotor assembly 12 is shown in isolation in FIG. 6, whilst a suitable frame 14 is shown in isolation in FIG. 7.

The rotor assembly 12 comprises a shaft 16 on which is mounted a rotor core permanent magnet 18, a first balancing ring 20, a second balancing ring 22, and first 24 and second 26 bearings mounted on the shaft 16 on either side of the rotor core permanent magnet 18 and balancing rings 20, 22. An impeller 28 is mounted at one end of the shaft 16, and a sensor magnet 30 is mounted at the other end.

Although not shown in FIG. 6, the first bearing 24 is provided with annular grooves on the outer circumferential surface thereof. O-rings 32 sit within the annular grooves in order that the O-rings 32 remain in a desired position on the first bearing 24 and will not move around. When the rotor assembly 12 is mounted within the frame 14, the first bearing 24 sits inside a first bearing seat 42 in the frame 14, and is soft mounted thereto by way of the O-rings 32.

The second bearing 26 comprises first 34 and second 36 annular grooves formed on the outer circumferential surface thereof. The first annular groove 34 provides a channel in which a first adhesive 35 can be located, as will be described in more detail hereafter. In a similar manner, the second annular groove 36 also provides a channel in which a tacking adhesive 37 can be located. Whilst the first annular groove 34 is depicted here as being present on the second bearing 26, it will be appreciated by the person skilled in the art that the first annular groove 34 could be located on a second bearing seat 44 of the frame 14 whilst achieving the beneficial effects of the present invention.

The frame 14 is a one-piece construction, for example moulded as a single object, and comprises a generally cylindrical main body 38, and an impeller shroud 40 for covering the impeller 28 of the rotor assembly 12.

The main body 38 comprises a first bearing seat 42 formed at an end closest to the impeller shroud 40, and a second bearing seat 44 formed at the opposing end of the main body 38, furthest away from the impeller shroud 40. Each bearing seat 42,44 comprises an annular collar for receiving a corresponding bearing 24,26 therein. Four slots 46 extend longitudinally along the main body 38 between the first 42 and second 44 bearing seats, with the slots 46 being equally spaced about the circumference of the main body 38. The slots 46 are shaped and dimensioned to receive corresponding stator core assemblies 52 of the electric motor 10.

The second bearing seat 44 comprises an aperture 48 and a cut-out 50. The aperture 48 extends through the second bearing seat 44 to form an adhesive channel therethrough, and is shaped and dimensioned to receive an appropriate adhesive injection nozzle. The internal diameter of the aperture 48 is substantially equal to the width of the first annular groove 34 of the second bearing 26. The aperture 48 is substantially aligned with a central axis of one of the slots 46.

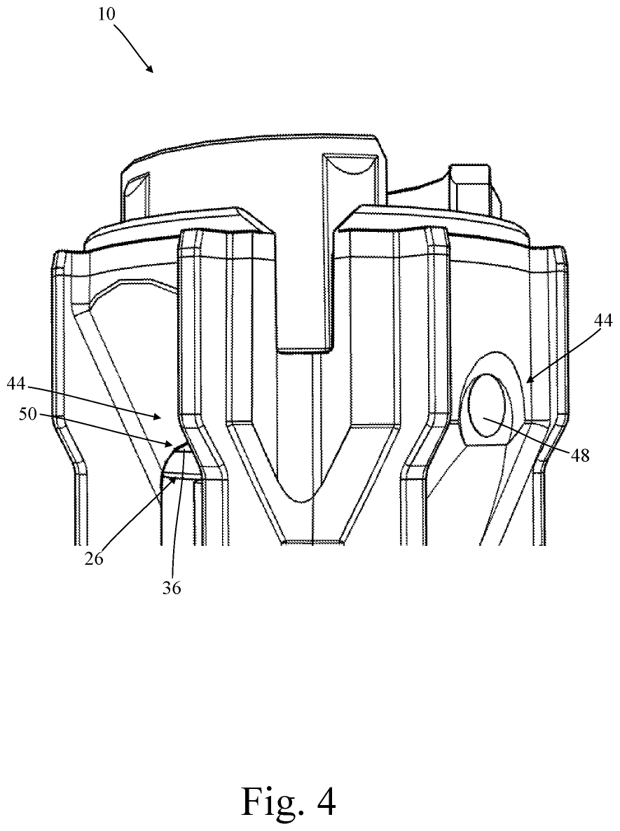

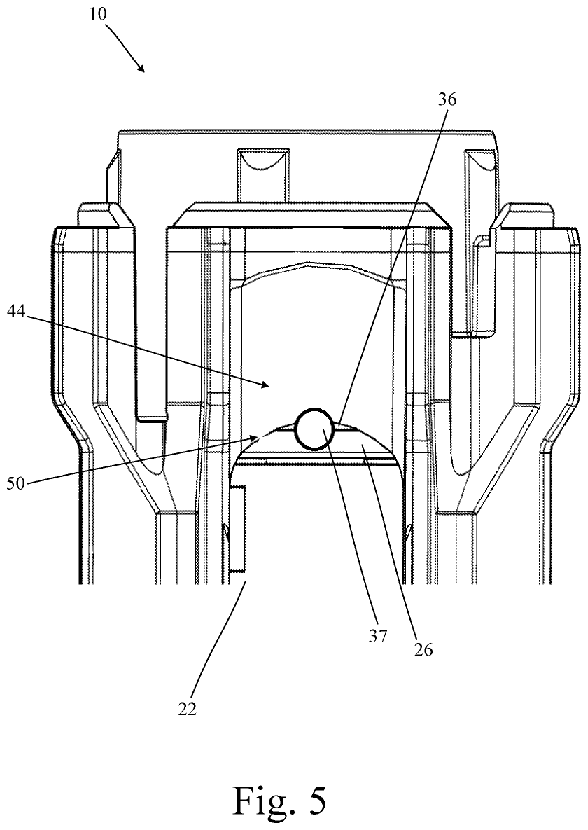

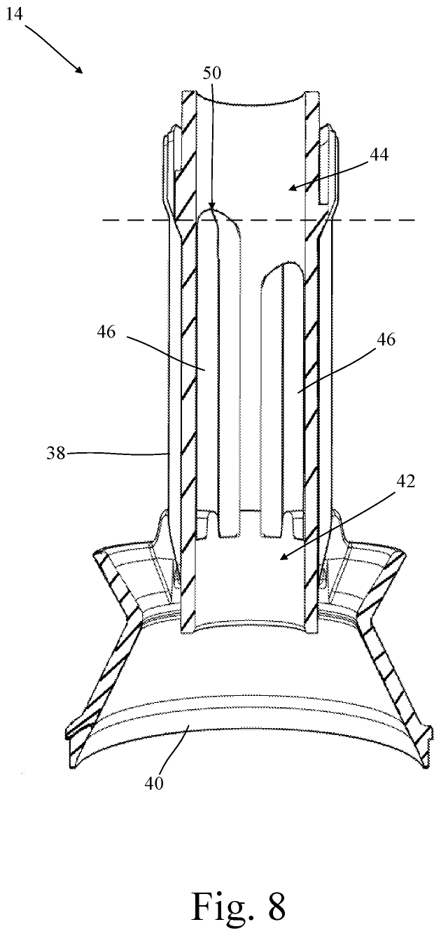

The cut-out 50 is formed in a region of the second bearing seat 44 closest to one of the slots 46, and is effectively an extension of one of the slots 46 into the second bearing seat 44. The dashed line in FIG. 8 indicates roughly where the lowermost edge of the second bearing 26 lies in relation to the second bearing seat 44 when the rotor assembly 12 is mounted to the frame 14. As can be seen from FIGS. 4, 5 and 8, the second bearing 26 is thus located within the second bearing seat 44 such that the cut-out 50 exposes the second annular groove 36 of the second bearing 26 when the rotor assembly 12 is mounted to the frame 14. The cut-out 50 is disposed about 90° around the circumference of the main body 38 from the aperture 48.

Returning to the first embodiment of the method 100, the method 100 comprises locating 104 the second bearing 26 within the second bearing seat 44. The second bearing 26 is located within the second bearing seat 44 such that the first annular groove 34 of the second bearing 26 is substantially aligned with the aperture 48 of the second bearing seat 44. Thus an interface is formed between the second bearing 26 and the internal surface of the second bearing seat 44.

An adhesive 35, referred to hereafter as a first adhesive, is injected 106 through the aperture 48, for example using an appropriate adhesive injection nozzle inserted into the aperture 48, such that the first adhesive 35 flows into the first annular groove 34 of the second bearing 26. The first adhesive 35 is of a form which enables relative movement between the second bearing 26 and the second bearing seat 44 once injection of the first adhesive 35 has been completed.

In a presently preferred embodiment the first adhesive 35 used is a heat cured structural adhesive, and is the adhesive known as Loctite® 9492 available from Henkel Loctite. This may be particularly beneficial as the first adhesive 35 is located in the first annular groove 34 of the second bearing 26, between the second bearing 26 and the second bearing seat 44 of the frame 14, and hence is not visible. Curing of the first adhesive 35 may therefore prove difficult using, for example, a UV curing method, as it may prove difficult to ensure that the UV light can reach the first adhesive 35, and thus may prove difficult to fully cure the first adhesive. By using a heat cured adhesive it may be possible to ensure that the first adhesive 35 is fully cured, thereby ensuring a strong and reliable bond is formed.

The method comprises affecting relative movement 108 between the second bearing 26 and the second bearing seat 44. This acts to spread the first adhesive 35 contained in the first annular groove 34 of the second bearing 26 along the interface between the second bearing 26 and the inner surface of the second bearing seat 44, thereby increasing the bond surface area, which may result in an increased strength of bond. By affecting relative movement 108 between the second bearing 26 and the second bearing seat 44, correct alignment of the rotor assembly 12 relative to the frame 14 can also be achieved. In presently preferred embodiments the rotor assembly 12 is moved relative to the frame 14, although it will be appreciated that moving the frame 14 relative to the rotor assembly 12 can achieve the same result.

The first adhesive 35 is then cured 110 by placing the combined rotor assembly 12 and frame 14 in an oven at 80° C. for at least 20 minutes.

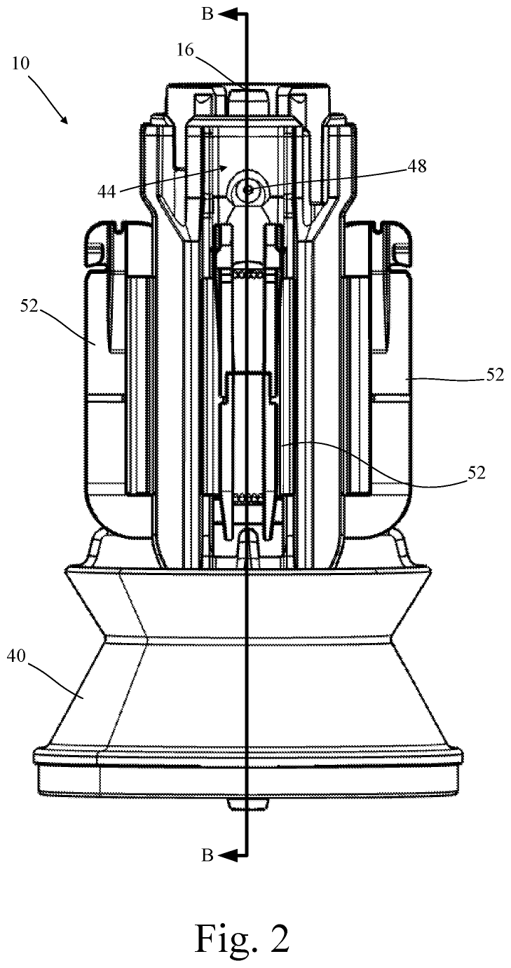

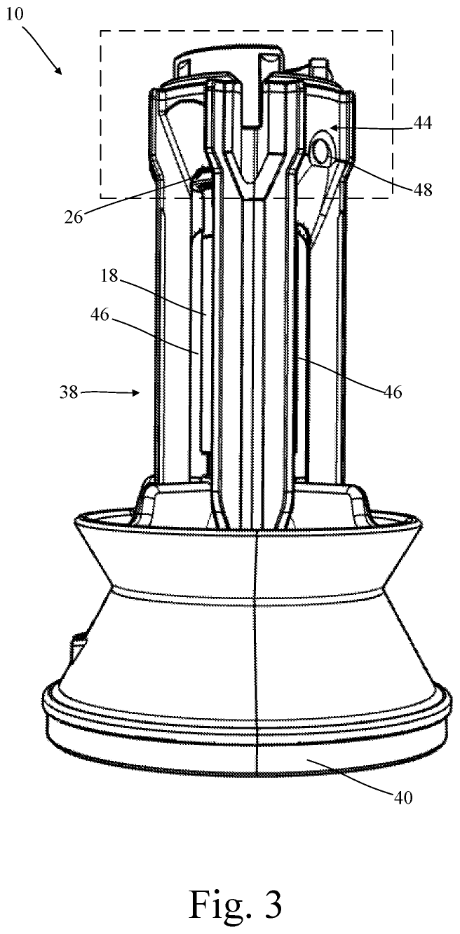

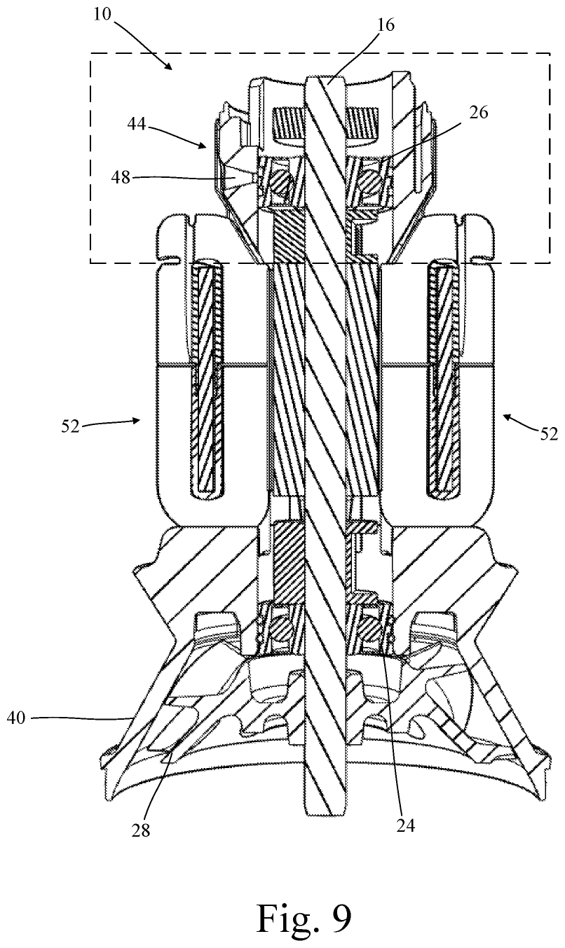

The combined rotor assembly 12 and frame 14 can be seen in FIGS. 2-5 and 9-10 as part of the electric motor 10. The stator core assemblies 52 are shown inserted into their respective slots 46 in FIGS. 2 and 9, and the rotor assembly 12 is mounted to the frame 14 such that the first 24 and second 26 bearings are located in their respective first 42 and second 44 bearing seats.

The first bearing 24 is soft-mounted to the first bearing seat 42 by the O-rings 32. Because the first bearing 24 is only soft mounted within the first bearing seat 42 by way of the O-rings 32, it is able to absorb any radial forces generated by the impeller 28 as it spins during use.

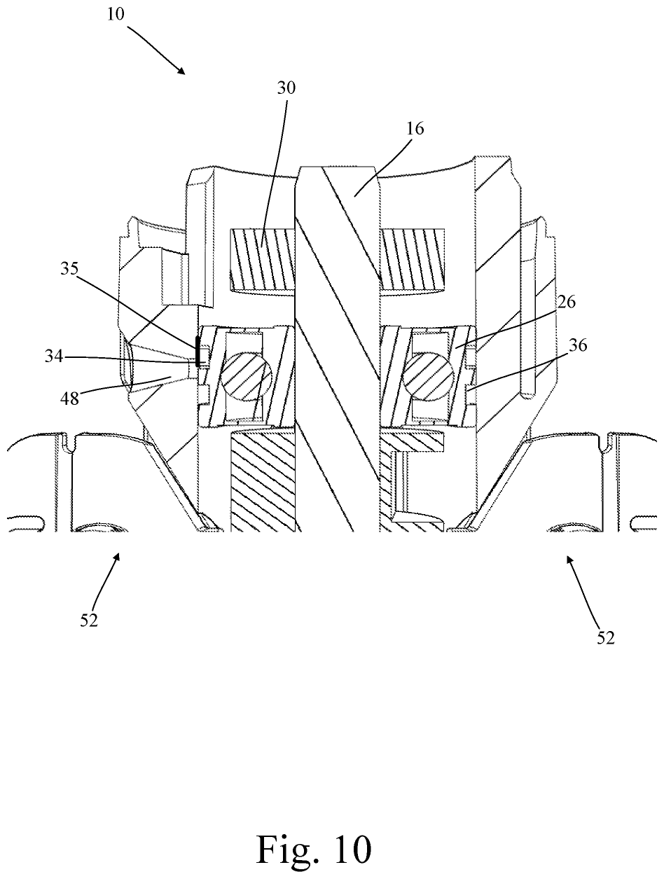

The second bearing 26 is mounted to the second bearing seat 44 by the adhesive injected into the first annular groove 34. As a result of the adhesive bond, the second bearing 26 is able to withstand axial forces along the rotor assembly 12 that are generated by the impeller 28 during use. As can be seen most clearly in FIG. 10, the first annular groove 34 is misaligned with the aperture 48 as a result of relative movement between the second bearing 26 and the second bearing seat 44 during assembly.

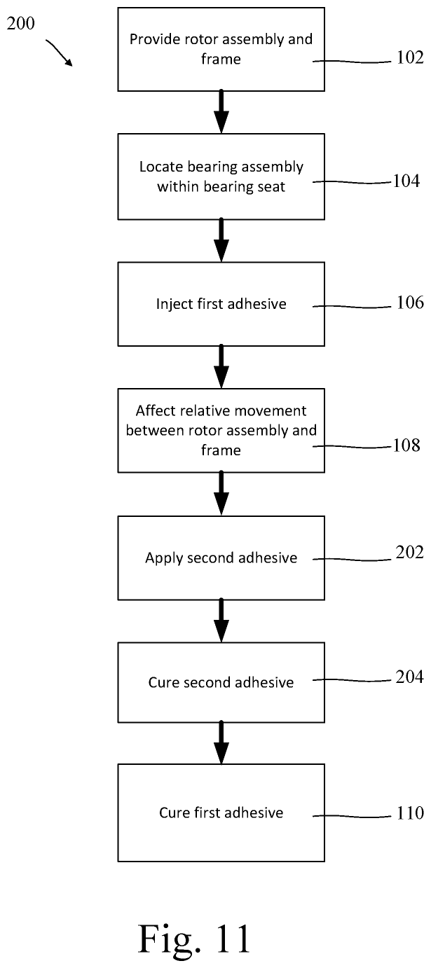

A second embodiment of a method, generally designated 200, of mounting a rotor assembly 12 to a frame 14 of an electric motor 10, is shown schematically in FIG. 11.

The second embodiment of the method 200 is substantially the same as the first embodiment of the method 100, but comprises the additional steps of applying 202 a second adhesive 37 at the cut-out 50, and curing 204 the second adhesive 37 before curing 110 the first adhesive 35.

Following relative movement between the second bearing 26 and the second bearing seat 44, the second annular groove 36 of the second bearing 26 is exposed through the cut-out 50 in the second bearing seat 44. The second adhesive 37 is applied at the cut-out 50 such that the second adhesive 37 covers at least a portion of the second bearing seat 44 and flows into the second annular groove 36.

The second adhesive 37 is a quick UV curing adhesive, and in a presently preferred embodiment is the adhesive known as Loctite® 3556 available from Henkel Loctite. The second adhesive 37 is cured by applying UV light with a wavelength of 365 nm for a period of 5 seconds. Following the curing 204 of the second adhesive 37, the first adhesive 35 can be heat cured 110, as discussed above.

As the first adhesive 35 needs to be heat cured, which may take a relatively long period of time, there is a risk that the rotor assembly 12 and the frame 14 may become misaligned during the curing process, and indeed there is a risk that the rotor assembly 12 and the frame 14 may become misaligned during transportation of the components to an oven for the curing process to take place. This risk of misalignment can be mitigated by the application of the second adhesive 37 to form a quick, relatively low strength, bond between the rotor assembly 12 and the frame 14. The bond formed by the second adhesive 37 is sufficient to fix the rotor assembly 12 to the frame 14 at a desired position until the curing process 110 for the adhesive has been completed.

1. A method of mounting a rotor assembly to a frame of an electric motor, the method comprising providing a rotor assembly having a bearing, providing a frame having a bearing seat, the bearing seat comprising an aperture, and the bearing and/or an internal surface of the bearing seat comprising an annular groove, locating the bearing within the bearing seat, injecting an adhesive through the aperture into the annular groove, affecting relative movement between the bearing and the bearing seat, and curing the adhesive.

2. The method of claim 1, wherein affecting relative movement between the bearing and the bearing seat comprises affecting relative movement in an axial direction.

3. The method of claim 1, wherein the annular groove is located on the bearing, and locating the bearing within the bearing seat comprises locating the bearing such that the aperture and the annular groove are aligned.

4. The method of claim 3, wherein affecting relative movement between the bearing and the bearing seat comprises affecting relative movement such that the aperture and the annular groove are at least partially misaligned.

5. The method of claim 3, wherein locating the bearing within the bearing seat comprises locating the bearing such that opposing edges of the annular groove are coincident with corresponding opposing points on the perimeter of the aperture.

6. The method of claim 1, wherein curing the adhesive comprises using a heat curing process.

7. The method of claim 1, wherein the method comprises applying a tacking adhesive at an interface between the bearing and an external surface of the bearing seat, and curing the tacking adhesive before curing the adhesive.

8. The method of claim 7, wherein curing the tacking adhesive comprises using a UV curing process.

9. An electric motor comprising a rotor assembly having a bearing, and a frame having a bearing seat for receiving the bearing, wherein the bearing seat comprises an aperture, the bearing comprises an annular groove for receiving adhesive injected through the aperture, and the annular groove is at least partially misaligned with the aperture.

10. The method of claim 9, wherein the bearing seat comprises a cut-out through which a portion of the bearing is exposed.

11. The method of claim 10, wherein the bearing comprises a further groove, and the further groove is exposed through the cut-out.
